(19) United States
(12) Patent Application Publication
(10) Pub. No.: US 2024/0161359 A1
(43) Pub. Date: May 16, 2024

(54) RECOMMENDATION ENGINE FOR COMBINING IMAGES AND GRAPHICS OF SPORTS CONTENT BASED ON ARTIFICIAL INTELLIGENCE GENERATED GAME METRICS

(71) Applicant: STATS LLC, Chicago, IL (US)

(72) Inventors: Patrick Joseph Lucey, Chicago, IL (US); Anthony Borsumato, Cambridge (GB); Kevin Allinson, Yarm (GB); Christian MARKO, Graz (AT)

(73) Assignee: Stats LLC, Chicago, IL (US)

(21) Appl. No.: 18/422,404

(22) Filed: Jan. 25, 2024

Related U.S. Application Data
(63) Continuation of application No. 17/937,156, filed on Sep. 30, 2022.
(60) Provisional application No. 63/261,971, filed on Oct. 1, 2021.

(51) Int. Cl. G06T 11/20; G06V 20/40

(52) U.S. Cl. CPC G06T 11/206; G06V 20/42; G06V 20/44

(57) ABSTRACT

A computing system receives data for a game. The data includes at least one of tracking data or event data. Based on the data for the game, the computing system determines that an event has occurred within the game. Based on the determining, the computing system generates a graphic responsive to the event. The graphic includes insights related to the event. The computing system recommends an image relevant to the event based on metatags associated with the event. The computing system generates a visual element by merging the image and the graphic.

### CROSS-REFERENCE TO RELATED APPLICATIONS

This application claims priority to U.S. Provisional Application Ser. No. 63/261,971, filed Oct. 1, 2021, which is hereby incorporated by reference in its entirety.

### FIELD OF THE DISCLOSURE

The present disclosure generally relates to a recommendation engine for visualizations of sports content based on artificial intelligence generated game metrics.

### BACKGROUND

With the proliferation of data, sports teams, commentators, and fans alike are more interested in identifying and classifying events that occur throughout a game or across a season. As companies develop models configured to generate various predictions and metrics, surfacing these predictions and metrics to the user becomes increasingly important.

### SUMMARY

In some embodiments, a method is disclosed herein. A computing system receives data for a game. The data includes at least one of tracking data or event data. Based on the data for the game, the computing system determines that an event has occurred within the game. Based on the determining, the computing system generates a graphic responsive to the event. The graphic includes insights related to the event. The computing system recommends an image relevant to the event based on metatags associated with the event. The computing system generates a visual element by merging the image and the graphic. In some embodiments, the computing system may recommend an artificial intelligence (AI) metric or insight based on the event. Such recommendation may take the form of a single number, combination of numbers, or a visualization of the key play in terms of ball motion path (with or without the player tracking data) with the AI metric/insight.

In some embodiments, a non-transitory computer readable medium is disclosed herein. The non-transitory computer readable medium includes one or more sequences of instructions, which, when executed by one or more processors, causes a computing system to perform operations. The operations include receiving, by the computing system, data for a game, the data comprising at least one of tracking data or event data. The operations further include, based on the data for the game, determining, by the computing system, that an event has occurred within the game. The operations further include, based on the determining, generating, by the computing system, a graphic responsive to the event, wherein the graphic comprises insights related to the event. The operations further include recommending, by the computing system, an image relevant to the event based on metatags associated with the image. The operations further include generating, by the computing system, a visual element by merging the image with the graphic.

In some embodiments, a system is disclosed herein. The system includes a processor and a memory. The memory has programming instructions stored thereon, which, when executed by the processor, causes the system to perform operations. The operations include receiving data for a game, the data comprising at least one of tracking data or event data. The operations further include, based on the data for the game, determining that an event has occurred within the game. The operations further include, based on the determining, generating a graphic responsive to the event, wherein the graphic comprises insights related to the event. The operations further include recommending an image relevant to the event based on metatags associated with the image. The operations further include generating a visual element by merging the image with the graphic.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 illustrates an exemplary visual element, according to example embodiments.

FIG. 3 illustrates an exemplary visual element, according to example embodiments.

FIG. 4 is a flow diagram illustrating a method of generating a visual element, according to example embodiments.

FIG. 5A is a block diagram illustrating a computing device, according to example embodiments.

FIG. 5B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques described herein are generally directed to the merging of different types of content into a single visual element. For example, one or more techniques described herein eliminate what used to be a time consuming and highly subjective process for one that is intelligent, objective, and automatic. The present system may utilize a combination of metatags and event analysis to recommend an image to be associated with a graphic capturing insights related to an artificial intelligence metric or event.

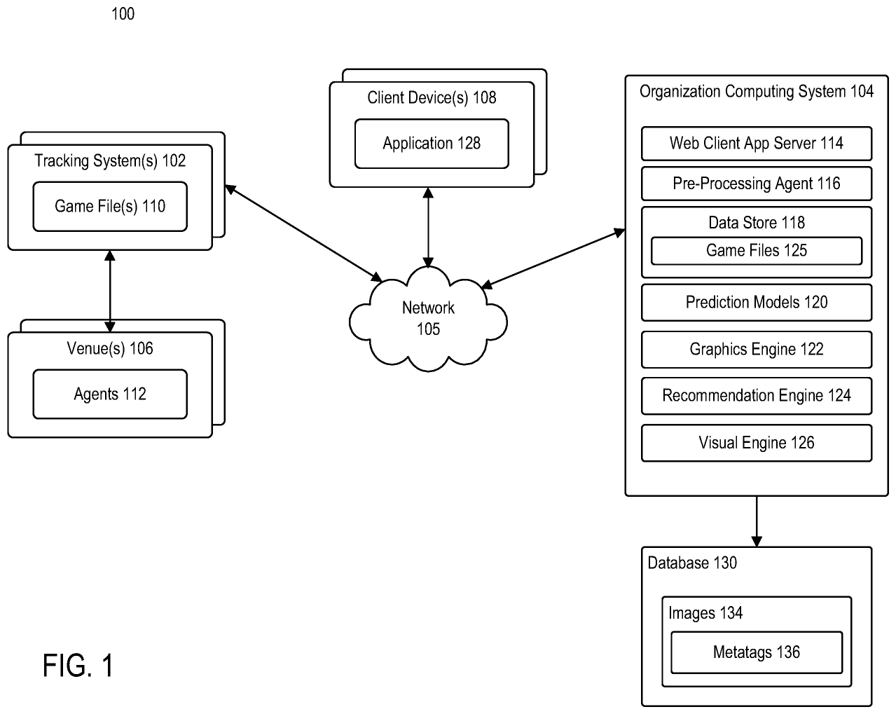

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to capture the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In another example, a mix of stationary and non-stationary cameras may be used to capture motions of all agents on the playing surface as well as one or more objects or relevance. As those skilled in the art recognize, utilization of such tracking system (e.g., tracking system 102) may result in many different camera views of the court (e.g., high sideline view, free-throw line view, huddle view, face-off view, end zone view, etc.). In some embodiments, tracking system 102 may be used for a broadcast feed of a given match. In such embodiments, each frame of the broadcast feed may be stored in a game file 110.

In some embodiments, game file 110 may further be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102. Organization computing system 104 may include at least a web client application server 114, a pre-processing agent 116, a data store 118, prediction models 120, graphics engine 122, recommendation engine 124, and visual engine 126.

Each of pre-processing agent 116, prediction models 120, graphics engine 122, recommendation engine 124, and visual engine 126 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 125. Each game file 125 may include video data of a given match. For example, the video data may correspond to a plurality of video frames captured by tracking system 102. In some embodiments, the video data may correspond to broadcast data of a given match, in which case, the video data may correspond to a plurality of video frames of the broadcast feed of a given match.

Pre-processing agent 116 may be configured to process data retrieved from data store 118. For example, pre-processing agent 116 may be configured to generate game files 125 stored in data store 118. For example, pre-processing agent 116 may be configured to generate a game file 125 based on data captured by tracking system 102. In some embodiments, pre-processing agent 116 may further be configured to store tracking data associated with each game in a respective game file 125. Tracking data may refer to the (x, y) coordinates of all players and balls on the playing surface during the game. In some embodiments, pre-processing agent 116 may receive tracking data directly from tracking system 102. In some embodiments, pre-processing agent 116 may derive tracking data from the broadcast feed of the game.

Prediction models 120 may be representative of one or more prediction models associated with STATS Perform, located in Chicago, Illinois. For example, prediction models 120 may be representative of one or more prediction models, such as, but not limited to, scoring prediction models, models that automatically detect events (e.g., in basketball—ball-screens, isolations, off-ball-screens, soccer: counter-attacks, set-plays), expected metrics (e.g., expected goals, expected possession and expected pass completion), player and team power rankings, player and team player prop predictions during the match or season simulation (both in terms of final table position as well as final player and team statistics at the end of the season), and the like.

In some embodiments, prediction models 120 may include prediction engines configured to accurately model defensive behavior and its effect on attacking behavior, such as that disclosed in U.S. application Ser. No. 17/649,970, which is hereby incorporated by reference in its entirety.

In some embodiments, prediction models 120 may include prediction models configured to accurately model or classify a team's playing style or a player's playing style, such as that disclosed in U.S. application Ser. No. 16/870,170, which is hereby incorporated by reference in its entirety.

In some embodiments, prediction models 120 may include prediction models configured to accurately model a team's offensive or defensive alignment, such as that disclosed in U.S. application Ser. No. 16/254,128, which is hereby incorporated by reference in its entirety.

In some embodiments, prediction models 120 may include prediction models configured to accurately model a team's formation, such as that disclosed in U.S. application Ser. No. 17/303,361, which is hereby incorporated by reference in its entirety.

In some embodiments, prediction models 120 may include prediction models configured to generate macro predictions and/or micro predictions in sports, such as that disclosed in U.S. application Ser. No. 17/651,960, which is hereby incorporated by reference in its entirety.

In some embodiments, prediction models 120 may include prediction models configured to accurately predict an outcome of an event or game, such as that disclosed in U.S. application Ser. No. 16/254,108, which is hereby incorporated by reference in its entirety.

In some embodiments, prediction models 120 may include prediction models configured to accurately predict an outcome of an event or game, such as that disclosed in U.S. application Ser. No. 16/254,088, which is hereby incorporated by reference in its entirety.

In some embodiments, prediction models 120 may include prediction models configured to accurately generate in-game insights, such as that disclosed in U.S. application Ser. No. 17/653,394, which is hereby incorporated by reference in its entirety.

In some embodiments, prediction models 120 may include prediction models configured to generate possible outcomes for an event (such as an at-bat in cricket), such as that disclosed in U.S. application Ser. No. 17/934,756, which is hereby incorporated by reference in its entirety.

Graphics engine 122 may be configured to generate one or more graphics that may include sports data and insights generated by prediction models 120. For example, graphics engine 122 may generate high-resolution player and team images, videos, GIFs, and the like that may be matched with real-time or near real-time sports data and insights. Graphics engine 122 may, generally, be representative of Opta Graphics, an intuitive multi-media graphics tool, commercially available from STATS Perform.

Recommendation engine 124 may be configured to recommend an image to include in a graphic generated by graphics engine 122. For example, based on an AI metric or event that triggered graphics engine 122 to generate a graphic capturing the AI metric or event, recommendation engine 124 may identify or recommend an image relevant to the AI metric or event. Conventionally, such process was a manual process, in which an administrator would need to select an image to be added to the graphic generated by graphics engine 122. Recommendation engine 124 eliminates this time-consuming and subjective process by utilizing a combination of metatags to identify an image relevant to the AI metric or event.

Recommendation engine 124 may communicate with database 130 to identify an image relevant to the graphic generated by graphics engine 122. As shown, database 130 may include images 134. Images 134 may be various sports-related images, such as, but not limited to, players, coaches, fans, plays, events, and the like. Each image 134 may include one or more metadata tags 136 associated therewith. As provided above, graphics engine 122 may generate a graphic associated with one or more artificial intelligence contextual features. These contextual features may be associated with various metadata tags 136. In this manner, recommendation engine 124 may select an image 134 that includes metadata tags 136 relevant to the artificial intelligence contextual features. In some embodiments the selected image may include a shot (expected goal), or a possession (expected possession), or a specific event (ball-screen in basketball or counter-attack/corner in soccer) or in terms of the predictions of performance for the match for a specific statistics, or end of season ranking.

In some embodiments, recommendation engine 124 may recommend a list of images (e.g., more than one image) for inclusion with the graphic generated by graphics engine 122. For example, a human operator may look through all the list of images recommended by recommendation engine 124. In comparison, the human operator may have to previously sift through a large database of images, many of which may not be relevant to an event trigger. In some embodiments, recommendation engine 124 may provide an insight as to why each image in the list of images is relevant.

Visual engine 126 may be configured to merge the recommended image with the generated graphic for presentation to the user. Such result may be referred to as a visual element. For example, a visual element may include a graphic generated by graphics engine 122 and a recommended image provided by recommendation engine 124.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 128. Application 128may be representative of a web browser that allows access to a website or a stand-alone application. Client device 108 may access application 128 to access one or more functionalities of organization computing system 104. Client device 108 may communicate over network 105 to request a webpage, for example, from web client application server 114 of organization computing system 104. For example, client device 108 may be configured to execute application 128 to access one or more merged graphics generated by graphics engine 122. The content that is displayed to client device 108 may be transmitted from web client application server 114 to client device 108, and subsequently processed by application 128 for display through a graphical user interface (GUI) of client device 108.

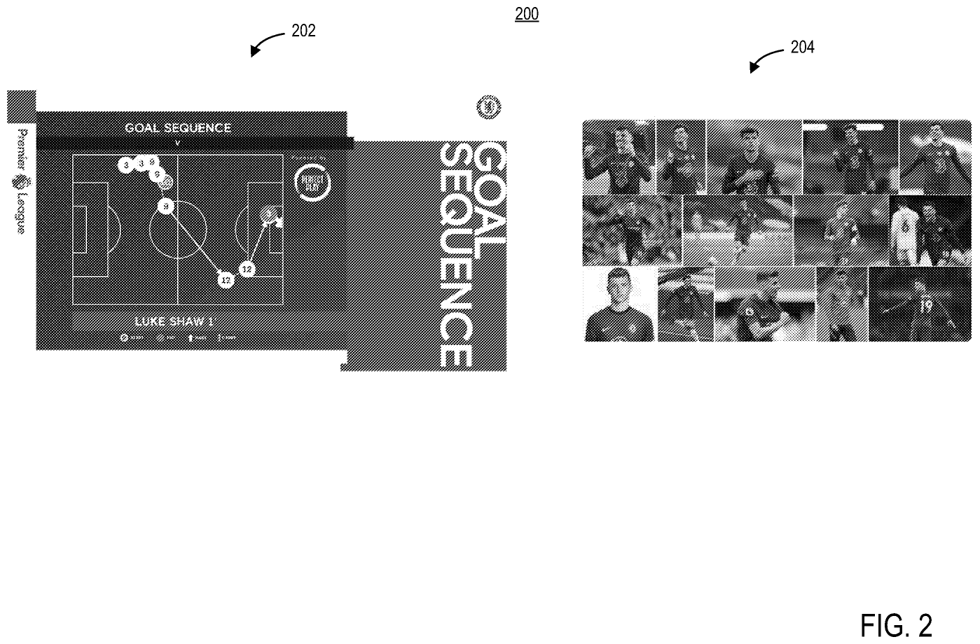

FIG. 2 illustrates an exemplary visual element 200, according to example embodiments. Visual element 200 may include a graphic 202 and a recommended image 204. Graphic 202 may be a graphic generated by graphics engine 122. For example, as shown, graphic 202 may correspond to a graphic generated by graphics engine 122, responsive to a goal scored by Nashville SC. Based on this event, recommendation engine 124 may recommend recommended image 204. Recommended image 204 may be an image that includes an advanced metric, such as live win probability (as shown), expected goal value, expected possession value, a possession sequence visual, or the like. Such recommended image 204 may provide the end user with more context or insight into the event.

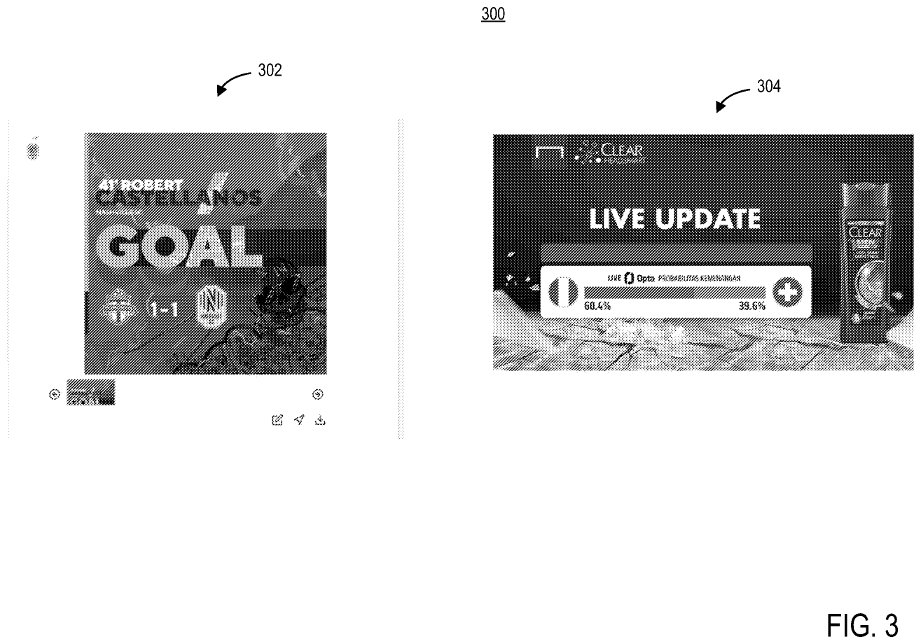

FIG. 3 illustrates an exemplary visual element 300, according to example embodiments. Visual element 300 may include a graphic 302 and a plurality of recommended images 304. Graphic 302 may be a graphic generated by graphics engine 122. For example, as shown, graphic 302 may correspond to a graphic generated by graphics engine 122, responsive to a goal being scored. Here, graphic 302 may illustrate a goal sequences corresponding to the goal. Based on this event, recommendation engine 124 may recommend recommended image 204. As shown, there may be several recommended images 304 that may be relevant to the event. For example, recommended images 304 may include, but are not limited to, images of the players that scored the goal, images of the player at night (if the game is at night), images of the player during the day (if the game is during the day), images of the player celebrating, images of the player in a specific jersey (home jersey, away jersey, alternate jersey), and the like. Based on the recommended images 304, recommendation engine 124 may select an image for inclusion in visual element 300. Such recommended image of the plurality of recommended images 304 may be provided to the end user.

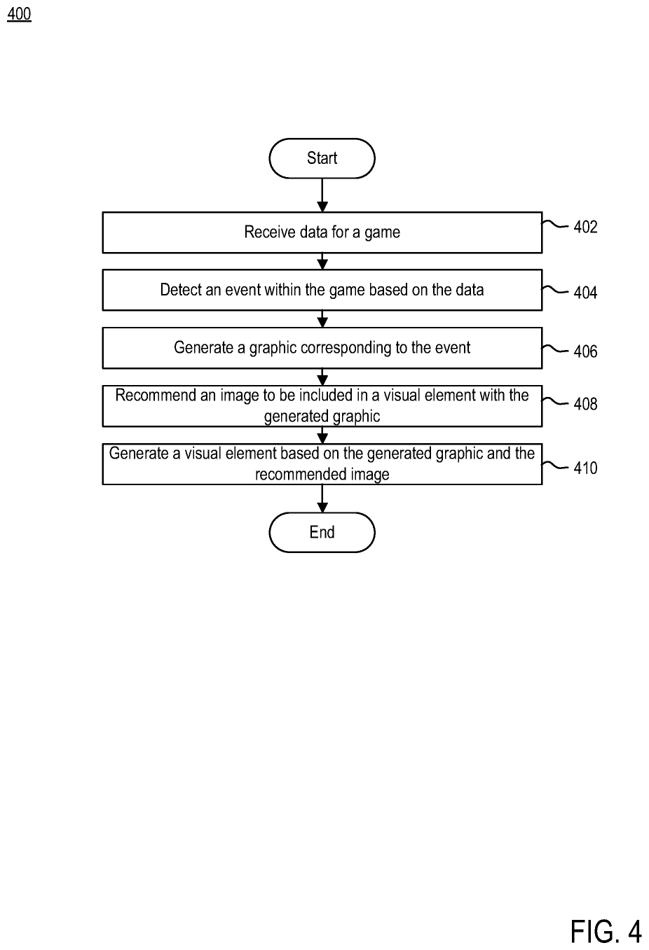

FIG. 4 is a flow diagram illustrating a method 400 of generating a visual element, according to example embodiments. Method 400 may begin at step 402.

At step 402, organization computing system 104 may receive data for a game. In some embodiments, the data may include tracking data for the game. In some embodiments, tracking data may be received from tracking system 102. In some embodiments, tracking data may be derived from a broadcast video stream of the game. In some embodiments, the data may include event data for the game. In some embodiments, prediction models 120 and/or pre-processing agent 116 may generate or derive the event data from the tracking data and/or broadcast data. In some embodiments, event data may be received from tracking system 102.

At step 404, organization computing system 104 may detect an event within the game based on the data. In some embodiments, pre-processing agent 116 may detect an event within the data by analyzing tracking data and/or event data. In some embodiments, prediction models 120 may detect an event within the data utilizing one or more machine learning algorithms. An event may refer to a goal, a pass, a record breaking event, and the like.

At step 406, organization computing system 104 may generate a graphic corresponding to the event. For example, responsive to detecting an event within the game, graphics engine 122 may be configured to generate one or more graphics that may include sports data and insights, generated by prediction models 120, that may be related to the event. For example, graphics engine 122 may generate a high-resolution images, videos, GIFs, or the like that may be matched with real-time or near real-time sports data and insights related to the event. Graphics engine 122 may, generally, be representative of Opta Graphics, an intuitive multi-media graphics tool, commercially available from STATS Perform.

At step 408, organization computing system 104 may recommend an image to be included in a visual element with the generated graphic. For example, recommendation engine 124 may recommend an image to include in a visual element with the graphic generated by graphics engine 122. For example, based on an AI metric or event that triggered graphics engine 122 to generate a graphic capturing the AI metric or event, recommendation engine 124 may identify or recommend an image relevant to the AI metric or event. To identify the recommended image, recommendation engine 124 may leverage metatags in database 130 of images 134 to identify an image relevant to the AI metric or event.

In some embodiments, organization computing system 104 may further recommend an AI metric or insight based on the event. For example, recommendation engine 124 may recommend an AI metric or insight to be included in the visual element.

At step 410, organization computing system 104 may generate a visual element based on the graphic generated by graphics engine 122 and the recommended image selected by recommendation engine 124. For example, visual engine 126 may merge the recommended image with the graphic generated by graphics engine 122 to generate the visual element.

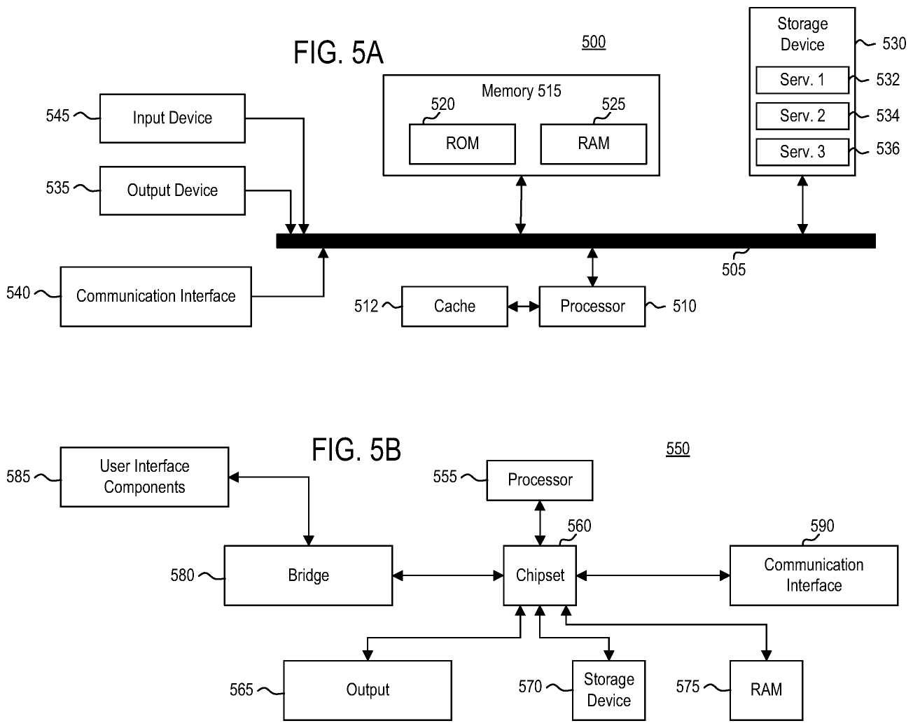

FIG. 5A illustrates an architecture of computing system 500, according to example embodiments. System 500 may be representative of at least a portion of organization computing system 104. One or more components of system 500 may be in electrical communication with each other using a bus 505. System 500 may include a processing unit (CPU or processor) 510 and a system bus 505 that couples various system components including the system memory 515, such as read only memory (ROM) 520 and random access memory (RAM) 525, to processor 510. System 500 may include a cache of high-speed memory connected directly with, in close proximity to, or integrated as part of processor 510. System 500 may copy data from memory 515 and/or storage device 530 to cache 512 for quick access by processor 510. In this way, cache 512 may provide a performance boost that avoids processor 510 delays while waiting for data. These and other modules may control or be configured to control processor 510 to perform various actions. Other system memory 515 may be available for use as well. Memory 515 may include multiple different types of memory with different performance characteristics. Processor 510 may include any general purpose processor and a hardware module or software module, such as service 1 532, service 2 534, and service 3 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction with the computing system 500, an input device 545 may represent any number of input mechanisms, such as a microphone for speech, a touch-sensitive screen for gesture or graphical input, keyboard, mouse, motion input, speech and so forth. An output device 535 (e.g., display) may also be one or more of a number of output mechanisms known to those of skill in the art. In some instances, multimodal systems may enable a user to provide multiple types of input to communicate with computing system 500. Communications interface 540 may generally govern and manage the user input and system output. There is no restriction on operating on any particular hardware arrangement and therefore the basic features here may easily be substituted for improved hardware or firmware arrangements as they are developed.

Storage device 530 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 525, read only memory (ROM) 520, and hybrids thereof.

Storage device 530 may include services 532, 534, and 536 for controlling the processor 510. Other hardware or software modules are contemplated. Storage device 530 may be connected to system bus 505. In one aspect, a hardware module that performs a particular function may include the software component stored in a computer-readable medium in connection with the necessary hardware components, such as processor 510, bus 505, output device 535, and so forth, to carry out the function.

FIG. 5B illustrates a computer system 550 having a chipset architecture that may represent at least a portion of organization computing system 104. Computer system 550 may be an example of computer hardware, software, and firmware that may be used to implement the disclosed technology. System 550 may include a processor 555, representative of any number of physically and/or logically distinct resources capable of executing software, firmware, and hardware configured to perform identified computations. Processor 555 may communicate with a chipset 560 that may control input to and output from processor 555. In this example, chipset 560 outputs information to output 565, such as a display, and may read and write information to storage device 570, which may include magnetic media, and solid-state media, for example. Chipset 560 may also read data from and write data to RAM 575. A bridge 580 for interfacing with a variety of user interface components 585 may be provided for interfacing with chipset 560. Such user interface components 585 may include a keyboard, a microphone, touch detection and processing circuitry, a pointing device, such as a mouse, and so on. In general, inputs to system 550 may come from any of a variety of sources, machine generated and/or human generated.

Chipset 560 may also interface with one or more communication interfaces 590 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 555 analyzing data stored in storage device 570 or RAM 575. Further, the machine may receive inputs from a user through user interface components 585 and execute appropriate functions, such as browsing functions by interpreting these inputs using processor 555.

It may be appreciated that example systems 500 and 550 may have more than one processor 510 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1-20. (canceled)

21. A method comprising:
receiving, by a computing system, video data for a game;
determining, by the computing system, tracking data based on the video data;
determining, by the computing system and using a prediction model, an artificial intelligence metric based on the tracking data;
generating, by the computing system, a graphic responsive to determining the artificial intelligence metric, wherein the graphic comprises the artificial intelligence metric and one or more artificial intelligence contextual features associated with a plurality of metadata tags;
recommending, by the computing system, an image including at least one metadata tag of the plurality of metadata tags; and
generating, by the computing system, a visual element by merging the image with the graphic.

22. The method of claim 21, further comprising:
recommending, by the computing system and using the prediction model, an insight to be included in the visual element.

23. The method of claim 22, wherein the insight includes a prediction of an outcome of the game.

24. The method of claim 21, wherein the artificial intelligence metric is a single number or a combination of numbers.

25. The method of claim 21, wherein recommending, by the computing system, the image including at least one metadata tag of the plurality of metadata tags, comprises:
generating a list of a plurality of images, wherein each image of the plurality of images includes at least one metadata tag of the plurality of metadata tags; and
selecting the recommended image from the plurality of images.

26. The method of claim 21, wherein the recommended image includes a probability of a win, an expected goal value, an expected possession value, or a visual of a possession sequence.

27. The method of claim 21, further comprising:
generating, by the computing system and using the prediction model, insights related to the artificial intelligence metric.

28. A non-transitory computer readable medium comprising instructions that, when executed by one or more processors, cause a computing system to:
receive, by the computing system, video data for a game;
determine, by the computing system, tracking data based on the video data;
determine, by the computing system and using a prediction model, an artificial intelligence metric based on the tracking data;
generate, by the computing system, a graphic responsive to determining the artificial intelligence metric, wherein the graphic comprises the artificial intelligence metric and one or more artificial intelligence contextual features associated with a plurality of metadata tags;
recommend, by the computing system, an image including at least one metadata tag of the plurality of metadata tags; and
generate, by the computing system, a visual element by merging the image with the graphic.

29. The non-transitory computer readable medium of claim 28, wherein execution of the instructions further causes the computing system to:
recommend, by the computing system and using the prediction model, an insight to be included in the visual element.

30. The non-transitory computer readable medium of claim 29, wherein the insight includes a prediction of an outcome of the game.

31. The non-transitory computer readable medium of claim 28, wherein the artificial intelligence metric is a single number or a combination of numbers.

32. The non-transitory computer readable medium of claim 28, wherein recommending, by the computing system, the image including at least one metadata tag of the plurality of metadata tags, comprises:
generating a list of a plurality of images, wherein each image of the plurality of images includes at least one metadata tag of the plurality of metadata tags; and
selecting the recommended image from the plurality of images.

33. The non-transitory computer readable medium of claim 28, wherein the recommended image includes a probability of a win, an expected goal value, an expected possession value, or a visual of a possession sequence.

34. The non-transitory computer readable medium of claim 28, wherein execution of the instructions further causes the computing system to:
generate, by the computing system and using the prediction model, insights related to the artificial intelligence metric.

35. A system, comprising:
a processor; and
a memory having programming instructions stored thereon, which, when executed by the processor, causes the system to perform operations comprising:
receiving video data for a game;
determining tracking data based on the video data;
determining, using a prediction model, an artificial intelligence metric based on the tracking data;
generating, a graphic responsive to determining the artificial intelligence metric, wherein the graphic comprises the artificial intelligence metric and one or more artificial intelligence contextual features associated with a plurality of metadata tags;
recommending an image including at least one metadata tag of the plurality of metadata tags; and
generating a visual element by merging the image with the graphic.

36. The system of claim 35, wherein the operations further comprise:
recommending, using the prediction model, an insight to be included in the visual element.

37. The system of claim 36, wherein the insight includes a prediction of an outcome of the game.

38. The system of claim 35, wherein recommending the image including at least one metadata tag of the plurality of metadata tags, comprises:
generating a list of a plurality of images, wherein each image of the plurality of images includes at least one metadata tag of the plurality of metadata tags; and
selecting the recommended image from the plurality of images.

39. The system of claim 35, wherein the recommended image includes a probability of a win, an expected goal value, an expected possession value, or a visual of a possession sequence.

40. The system of claim 35, wherein the operations further comprise:
generating, using the prediction model, insights related to the artificial intelligence metric.
